(19) United States
(12) Patent Application Publication
(10) Pub. No.: US 2020/0180274 A1
(43) Pub. Date: Jun. 11, 2020

(54) VEHICLE STRUCTURE AND METHOD FOR CABIN NOISE REDUCTION

(71) Applicant: CORNING INCORPORATED, CORNING, NY (US)

(72) Inventors: Vikram Bhatia, Painted Post, NY (US); William Keith Fisher, Corning, NY (US)

(21) Appl. No.: 16/623,590

(22) PCT Filed: Jun. 28, 2018
(86) PCT No.: PCT/US2018/040063

§ 371 Date: Dec. 17, 2019

Related U.S. Application Data
(60) Provisional application No. 62/526,055, filed on Jun. 28, 2017.

(51) Int. Cl. B32B 17/10; B60J 1/02; G10K 11/168

(52) U.S. Cl. CPC B32B 17/10036; B32B 17/10091; B60J 1/02; G10K 11/168; B32B 2605/12; B32B 2605/10; B32B 2605/18; B32B 2307/102; B32B 2605/006; B32B 2605/08

(57) ABSTRACT

Embodiments of a vehicle with reduced cabin noise are disclosed. In one or more embodiments, the vehicle includes a vehicle body enclosing an interior, a forward facing opening in communication with the interior, a windshield laminate having a first surface density (kg/m²) disposed in the forward facing opening, at least one side facing opening adjacent to the windshield, and a side window laminate having a surface density substantially equal to the first surface density disposed in the one side facing opening, wherein, within a frequency range from about 2500 Hz to about 8000 Hz, the windshield laminate comprises a first coincident dip minimum at a first frequency, and the side window laminate comprise a second coincident dip minimum at a second frequency, and wherein the first frequency and the second frequency differ by at least one one-sixth octave interval.

### CROSS REFERENCE TO RELATED APPLICATIONS

This application claims the benefit of priority under 35 U.S.C. § 119 of U.S. Provisional Application Ser. No. 62/526,055 filed on Jun. 28, 2017, the content of which is relied upon and incorporated herein by reference in its entirety.

### BACKGROUND

The disclosure relates to a vehicle structure, and to a method of cabin noise reduction in the vehicle.

The auto industry is moving toward using thinner glass components in glazing to reduce weight and improve fuel economy. One solution for thinner glass components includes, for example, a hybrid laminate combination of a relatively thicker annealed soda lime glass as the outer surface, a relatively thinner, chemically strengthened aluminosilicate glass, and an interlayer of a polyvinyl butyral (PVB). The hybrid laminate can reduce result in a 25% to 30% weight reduction compared to a conventional laminated, while providing significant improvement in durability and toughness.

A disadvantage of thinner, hybrid laminates can include a reduction in vehicle Noise-Vibration-Harshness (“NVH”) quality or performance (see SAEJ670e Standard, 1952, related to human audible and tactile sensations). In frequencies of from 200 to 1600 Hz, the attenuation of sound transmission into a vehicle through glazing can depend primarily on the surface density of the exterior of the hybrid laminate. The surface density of a laminated glass windshield can be, for example, from about 13.4 kg/m² for thick laminates and from about 7.3 kg/m² for thin laminates, depending on the laminate construction. Light weight glazing permits more sound in this frequency range to be transmitted into vehicle interiors. At frequencies from about 2500 Hz to 8000 Hz, the sound transmission can depend on glazing stiffness and damping. The stiffness and damping properties can be determined by glass thickness, the ratio of thicknesses of thick and thin glass sheets in hybrid laminate constructions (i.e., the symmetry ratio), and on the modulus and damping properties of an interlayer (e.g., PVB).

When the wavelength of incident sound waves matches some of the modes of a glazing panel, the sound transmission through the panel increases substantially over that predicted based on surface density alone. This wavelength matching typically occurs between 2500 Hz and 8000 Hz depending on stiffness of the glass panel. The frequency range over which sound transmission increases is called the coincidence frequency range. The sound transmission increases can be minimized by damping imparted by the PVB interlayer.

The increase in sound transmission caused by coincidence between incident sound wavelength in air and bending wavelengths in glass panels is characterized by measuring the panel sound transmission loss (STL) vs. frequency. STL measurement methods are defined in standards SAE J1400 and ASTM E90. An increase in sound transmission over a frequency range results in a decrease in the sound transmission loss over that frequency range. The decrease in the sound transmission loss over the coincidence frequency range is called the coincidence dip. The coincidence dip of a glazing panel acts like a band pass filter through which sound transmission is increased.

Two of the most significant airborne sound transmission paths into a vehicle interior are the windshield and front side windows. If the coincidence dip of these windows occurs over the same frequency band then sound transmission over that frequency band will be high.

Another major source of vehicle interior or cabin noise is wind noise. Wind noise is generated by turbulent pressure variations induced over the surface of a vehicle as the vehicle moves through air. The turbulent pressure variations can induce acoustic excitation of the vehicle's windows resulting in interior or cabin noise. In most vehicles the main transmission paths for wind noise are through the windshield and front side windows. Wind noise intensity can have a broad peak in the 3000 to 5000 Hz region.

Accordingly, there is a need for cabin noise reduction, while maintaining the light weight and performance benefits of thin, hybrid laminate glazing.

### SUMMARY

A first aspect of this disclosure pertains to a vehicle comprising: a vehicle body enclosing an interior; a forward facing opening in communication with the interior; a windshield laminate having a first surface density (kg/m²) disposed in the forward facing opening; at least one side facing opening adjacent the forward facing opening; and a side window laminate having a surface density substantially equal to the first surface density disposed in the one side facing opening, wherein, within a frequency range from about 2500 Hz to about 8000 Hz, the windshield laminate comprises a first coincident dip minimum at a first frequency, and the side window laminate comprise a second coincident dip minimum at a second frequency, and wherein the first frequency and the second frequency differ by at least one one-sixth octave interval.

A second aspect of this disclosure pertains to various methods for reducing vehicle cabin noise. In one or more embodiments, the method includes installing a windshield laminate, and at least a pair of front side window laminates in a vehicle cabin, wherein the windshield laminate has a first coincident dip minimum at a first frequency in a range from about 2500 Hz to about 8000 Hz, and the pair of front side facing windows laminate structure both have a second coincident dip minimum at a second frequency in the range from about 2500 Hz to about 8000 Hz, and wherein the first frequency and the second frequency differ by at least one one-sixth octave interval.

### BRIEF DESCRIPTION OF THE DRAWINGS

FIG. 1 shows the individually modeled coincidence dips (i.e. sound transmission loss minimums as a function of frequency) for three different laminate window structures and their resulting off-sets or separation from each other, according to one or more embodiments.

FIG. 2 shows the sound pressure level (SPL) (measured at a driver's ear) plots as a function of frequency for the combination of a windshield laminate with two glass sheets having a thickness of 2.5 mm each and a side window laminate with two glass sheets having a thickness of 1.5 mm each, and the combination of a windshield laminate with two glass sheets having a thickness of 2.0 mm each and a side window laminate with two glass sheets having a thickness of 2.0 mm each, according to one or more embodiments.

FIG. 3 compares the sound transmission loss (STL) as a function of frequency for a windshield laminate having two glass sheets with a thickness of 1.5 mm each, and a windshield laminate having a first glass sheet having a thickness of 2.5 mm and a second glass sheet having a thickness of 0.5 mm, according to one or more embodiments.

FIG. 4 shows the sound pressure level (SPL)(measured at a driver's ear) as function of frequency for the combination of a windshield laminate with a first glass sheet having a thickness of 2.5 mm and a second glass sheet having a thickness of 0.5 mm, and a side window laminate with a third glass sheet having a thickness of 2.5 mm and a fourth glass sheet having a thickness of 0.5 mm, and the combination of a windshield laminate with a first glass sheet having a thickness of 1.5 mm and a second glass sheet having a thickness of 1.5 mm, and a side window laminate with a third glass sheet having a thickness of 2.5 mm and a fourth glass sheet having a thickness of 0.5 mm (410), according to one or more embodiments.

FIG. 5 shows the sound transmission loss as a function of frequency for a laminate having two glass sheets with a thickness of 2.1 mm each, and a laminate having one glass sheet with a thickness of 1.8 mm and a second glass sheet with a thickness of 0.7 mm, where the coincidence dip minima are separated by two ⅓ octave intervals or bands, according to one or more embodiments.

FIG. 6 is a comparison of plots of sound pressure level as a function of frequency (SPL)(measured at a driver's ear) of a combination of a windshield laminate with two glass sheets with a thickness of 2.1 mm each and a side window laminate with a two glass sheets with a thickness of 2.1 mm each (600), and a combination of a windshield laminate with two glass sheets with a thickness of 2.1 mm and a side window laminate with first glass sheet having a thickness of 1.8 mm and a second glass sheet having a thickness of 0.7 mm (610), according to one or more embodiments.

FIG. 7 compares the curves of sound transmission loss as a function of frequency for a laminate having two glass sheets with a thickness of 2.1 mm each (700), and a laminate having a first glass sheet with a thickness of 2.1 mm and a second glass sheet with a thickness of 0.7 mm (710), wherein the laminates have different surface densities and their coincidence dip minimum frequencies are separated by one ⅓ octave interval (i.e., a ⅓ according to one or more embodiments.

FIG. 8 shows a comparison of the plots of sound pressure level (SPL)(measured at a driver's ear) as a function of frequency for a combination of a windshield laminate with two glass sheets having a thickness of 2.1 mm each (2.1/2.1), and a side window laminate with two glass sheets having a thickness of 2.1 mm each (800) (2.1/2.1), and a combination of a windshield laminate with two glass sheets having a thickness of 2.1 mm each (2.1/2.1) and a side window laminate with one glass sheet having a thickness of 2.1 mm and a second glass sheet having a thickness of 0.7 mm (2.1/0.7) (810), according to one or more embodiments.

FIG. 9 shows the curves of sound transmission loss as a function of frequency for a first laminate having a first glass sheet with thickness 3.2 mm and a second glass sheet with thickness 0.55 mm (900) (3.2/0.55) and a second laminate having a first glass sheet with thickness 2.9 mm and second glass sheet with thickness 0.9 mm (910) (2.9/0.9), where coincidence dip minima are separated by about one ⅙ octave band (i.e., a ⅙ O.I.), according to one or more embodiments.

FIG. 10 shows a comparison of the plots of sound pressure level (SPL)(measured at a driver's ear) as a function of frequency in a vehicle interior structure for the combination of a windshield laminate having a first glass sheet with a thickness of 2.9 mm and a second glass sheet with a thickness of 0.9 mm, and a side window laminate with a first glass sheet having a thickness of 3.2 mm and a second glass sheet with a thickness of 0.55 mm (1000), and for a combination of a windshield laminate with a first glass sheet having a thickness of 3.2 mm and a second glass sheet having a thickness of 0.55 mm and a side window laminate with a first glass sheet having a thickness of 3.2 mm and a second glass sheet having a thickness of 0.55 mm (1010) showing nearly identical or coincident curves), and showing the effect of off-setting coincidence dip minimum frequencies by one ⅙ octave band (i.e., a ⅙ O.I.), according to one or more embodiments.

FIG. 11 shows sound transmission loss v. frequency plots for a laminate having a first glass sheet with a thickness of 2.1 mm, interlayer of SPVB, and second glass sheet with a thickness of 1.6 mm, a laminate with a first glass sheet with thickness of 2.1 mm and second glass sheet with thickness of 0.7 mm, and a 3.85 mm-thick monolithic soda lime glass, according to one or more embodiments.

FIG. 12 shows a full system model SPL v. frequency for a combination of a windshield laminate with a first glass sheet with thickness of 2.1 mm, an interlayer of SPVB, and a second glass sheet with thickness of 1.6 mm (2.1/SPVB/1.6) and a 3.85 mm-thick monolithic soda lime glass side window (1510), and a combination of a windshield laminate with a first glass sheet with a thickness of 2.1 mm, an interlayer of SPVB, and a second glass sheet having a thickness of 1.6 mm (2.1/SPVB/1.6) and a side window laminate having a first glass sheet with thickness of 2.1 mm, and a second glass sheet with a thickness of 0.7 mm (2.1/0.7) (1500), according to one or more embodiments.

FIG. 13 shows a schematic of an exemplary vehicle cabin (1300) including: a windshield (1310); a left side window laminate (1320); a right side window laminate (1330); a left occupant (e.g., a driver) (1340); a right occupant (e.g., a passenger) (1350); and a microphone or sound sensor (1360) near the driver's ear, according to one or more embodiments.

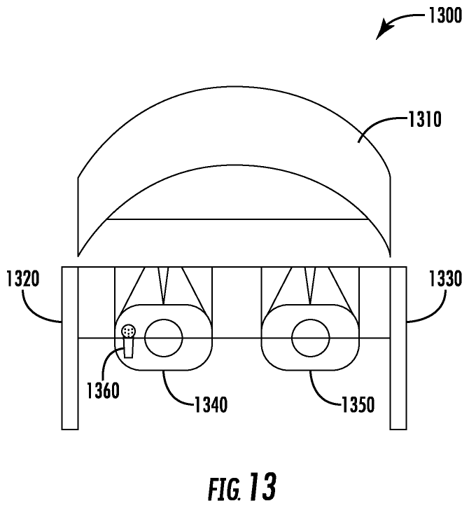

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

### Definitions

“Octave band,” “one-third octave band,” or like terms as used herein are known in the art of sound measurement, analysis, and scaling. The audible frequency range can be separated into unequal segments called octaves. A band is an octave in width when the upper band frequency is twice the lower band frequency. Octave bands can be separated into three ranges referred to as one-third-octave bands. A one-third octave band is a frequency band whose upper band-edge frequency (f2) is the lower band frequency (f1) times the cube root of two. Each octave band and ⅓ octave band can be identified by a middle frequency, a lower frequency limit and an upper frequency limit (see Acoustical Porous Material Recipes, apmr.matelys.com/Standards/OctaveBands.html, and engineeringtoolbox.comloctave-bands-frequency-limits-d_1602 html).

“Driver,” “passenger,” “occupant,” and like terms refer to a person, a sound recording microphone, or like human or non-human sound sensor situated in the vehicle cabin and within the interior volume defined by the outermost boundaries of the three-panel structure of the windshield and the nearest neighboring front side windows and associated glazing or like fixturing support (e.g., a frame), if any.

“Glass symmetry ratio,” and like terms refer to thickness ratio of thicker glass sheet to the thinner glass sheet in a laminate structure.

“Surface density” and like terms refer to the mass per unit area of a window (which includes a monolith or laminate constructions).

Laminate constructions may be described using the automotive industry shorthand that lists the thickness in mm of the exterior or outer sheet and the interior or inner sheet as follows: “Exterior/interior”, “outer/inner”, such as “2.5/2.5”. In this example, 2.5/2.5 may include a 2.5 mm exterior glass sheet, a resin interlayer (such as a PVB Saflex® QE51 acoustic resin), and a 2.5 mm interior glass sheet.

“Include,” “includes,” or like terms means encompassing but not limited to, that is, inclusive and not exclusive.

“Optional” or “optionally” means that the subsequently described event or circumstance can or cannot occur, and that the description includes instances where the event or circumstance occurs and instances where it does not.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).
Specific and preferred values disclosed for components, ingredients, additives, dimensions, conditions, times, and like aspects, and ranges thereof, are for illustration only; they do not exclude other defined values or other values within defined ranges. The composition and methods of the disclosure can include any value or any combination of the values, specific values, more specific values, and preferred values described herein, including explicit or implicit intermediate values and ranges.

In one or more embodiments, the full vehicle sound pressure level (SPL) versus frequency was modeled using an acoustic source. The intensity of this source was the same at each glazing position. This correspond to a vehicle in a tunnel surrounded by traffic and is also indicative of internal noise levels that would occur when a vehicle is exposed to external acoustic sources such as surrounding traffic, or other sources such as an operating jack hammer.

Experimentally the internal noise level of a vehicle when exposed to a uniform acoustic field is called the transparency test. In this test a vehicle is placed in a reverberant room and exposed to a uniform acoustic field generated by speakers in the room. The intensity of the acoustic field is the same at all glazing positions. Transparency is a standard test for some automotive OEM's where a minimum noise reduction level (NRL) is specified. NRL is the difference between the uniform source level (USL) and the internal SPL (NRL=USL−SPL). To meet the minimum NRL specification the internal SPL must be minimized. This is difficult when there is significant noise transmitted through glazing in the coincidence frequency range.

A first aspect of this disclosure pertains to a vehicle with a combination of glass laminates that exhibits reduced cabin noise. In one or more embodiments, the vehicle includes a vehicle body enclosing an interior (or cabin), a forward-facing opening in communication with the opening, a windshield laminate having a first surface density disposed in the forward-facing opening, at least one side facing opening adjacent the forward-facing opening, and a side window laminate having a surface density substantially equal to the first surface density disposed in the one side facing opening. In one or more embodiments, the side window laminate is positioned toward the front of the vehicle and adjacent to the windshield. In one or more embodiments, within a frequency range from about 2500 Hz to about 8000 Hz, the windshield laminate comprises a first coincidence dip minimum at a first frequency, and the side window laminate comprise a second coincidence dip minimum at a second frequency. In one or more embodiments, the first frequency and the second frequency are offset or differ. In one or more embodiments, the first frequency and the second frequency differ by at least one one-sixth (⅙) octave interval (O.I.), i.e., a ⅙ O.I., for example, from 300 to 1234 Hz such as 300, 346, 389, 436, 490, 550, 617, 693, 778, 873, 980, 1100, and 1234 frequency values. In one or more embodiments, the first frequency and the second frequency differ by, for example, approximately or exactly: one half of one-third octave intervals (i.e., 0.5 of a ⅓ O.I.), i.e., one one-sixth octave interval; one half to six one-third octave intervals (i.e., 0.5 to 6 (⅓ O.I.)), i.e., one one-sixth octave interval to six ⅓ octave intervals, for example, from 300 to 6900 Hz, such as 300, 346, 389, 436, 490, 550, 617, 693, 778, 873, 980, 1100, 1234, and 6900 Hz frequency values. In one or more embodiments, the first frequency and the second frequency differ by one to two ⅓ octave intervals (i.e., 1 to 2 (⅓ O.I.)), for example, from 825 to 3730 Hz, such as 825, 1040, 1310, 1480, 1650, 2080, 2350, 2620, and 3730 Hz frequency values. In one or more embodiments, the first frequency and the second frequency differ by at least two ⅓ octave intervals (i.e., 2 (⅓ O.I.)), for example, from 1480 to 3729 Hz or more, such as 1480, 2350, 3729 Hz, or greater. In one or more embodiments, the first frequency and the second frequency can be offset by, for example, at least two ⅓ octave intervals (i.e., at least 2 (⅓ O.I.)).

In one or more embodiments, the first coincidence dip minimum and the second coincidence dip occur at different frequencies and as such, the net sound transmission into the cabin will be less because one of the windows is transmitting while the other is blocking transmission. A used herein, the term “laminate” refers to the combination of two glass sheets with an intervening interlayer, which is polymeric.

In embodiments, the first frequency, the second frequency or both the first and second frequencies are less than 3000 Hz or greater than 5000 Hz.

A coincidence dip frequency range can be determined by glass stiffness, which depends on overall laminate thickness, and the symmetry ratio. The depth or minimum of the coincidence dip is determined by laminate damping, which can depend on viscoelastic properties of the interlayer resin composition such as a polyvinyl butyral (PVB), and the symmetry ratio.

In one or more embodiments, the vehicle includes laminates that achieve desired octave interval separations for their respective coincidence dip minimum, for example: adjusting or varying the thickness of the glass components of the selected laminate(s); adjusting or varying the thickness of the glass components of the selected laminate(s) and adjusting the symmetry ratio (i.e., thickness ratio of thicker glass ply or layer to the thinner glass ply or layer in a laminate or hybrid laminate structure); adjusting the symmetry ratio; and selecting an acoustic PVB for combination with the laminate.

In one or more embodiments, the windshield laminate and/or the side window laminate include with two glass sheets and an intervening interlayer. The two glass sheets may differ from one another in terms of thickness and strength level. The two glass sheets may differ from one another in terms of thickness and glass composition. The two glass sheets may differ from one another in terms of thickness, glass composition and strength level.

The glass sheets may be any one of a soda lime glass, aluminosilicate glass, borosilicate glass, boroaluminosilicate glass, alkali-containing aluminosilicate glass, alkali-containing borosilicate glass, and alkali-containing boroaluminosilicate glass.

In one or more embodiments, the windshield laminate and/or the side window laminate has a surface density in a range from about 7.3 kg/m² to 13.4 kg/m² (e.g., from about 7.3 kg/m² to 13.4 kg/m², from about 7.4 kg/m² to 13.4 kg/m², from about 7.5 kg/m² to 13.4 kg/m², from about 7.6 kg/m² to 13.4 kg/m², from about 7.7 kg/m² to 13.4 kg/m², from about 7.8 kg/m² to 13.4 kg/m², from about 7.9 kg/m² to 13.4 kg/m², from about 8 kg/m² to 13.4 kg/m², from about 8.2 kg/m² to 13.4 kg/m², from about 8.4 kg/m² to 13.4 kg/m², from about 8.5 kg/m² to 13.4 kg/m², from about 8.6 kg/m² to 13.4 kg/m², from about 8.8 kg/m² to 13.4 kg/m², from about 9 kg/m² to 13.4 kg/m², from about 9.2 kg/m² to 13.4 kg/m², from about 9.4 kg/m² to 13.4 kg/m², from about 9.5 kg/m² to 13.4 kg/m², from about 9.6 kg/m² to 13.4 kg/m², from about 9.8 kg/m² to 13.4 kg/m², from about 10 kg/m² to 13.4 kg/m², from about 10.5 kg/m² to 13.4 kg/m², from about 7.3 kg/m² to 13.2 kg/m², from about 7.3 kg/m² to 13 kg/m², from about 7.3 kg/m² to 12.8 kg/m², from about 7.3 kg/m² to 12.6 kg/m², from about 7.3 kg/m² to 12.5 kg/m², from about 7.3 kg/m² to 12.4 kg/m², from about 7.3 kg/m² to 12.2 kg/m², from about 7.3 kg/m² to 12 kg/m², from about 7.3 kg/m² to 11.8 kg/m², from about 7.3 kg/m² to 11.6 kg/m², from about 7.3 kg/m² to 11.5 kg/m², from about 7.3 kg/m² to 11.4 kg/m², from about 7.3 kg/m² to 11.2 kg/m², from about 7.3 kg/m² to 11 kg/m², from about 7.3 kg/m² to 10.8 kg/m², from about 7.3 kg/m² to 10.6 kg/m², from about 7.3 kg/m² to 10.5 kg/m², from about 7.3 kg/m² to 10.4 kg/m², from about 7.3 kg/m² to 10.2 kg/m², from about 7.3 kg/m² to 10 kg/m², or from about 7.3 kg/m² to 9.5 kg/m².

With respect to strength level, one of the glass sheets may be strengthened to include a compressive stress that extends from a surface to a depth of compression or depth of compressive stress layer (DOC). The compressive stress at the surface is referred to as the surface CS. The CS regions are balanced by a central portion exhibiting a tensile stress. At the DOC, the stress crosses from a compressive stress to a tensile stress. The compressive stress and the tensile stress are provided herein as absolute values.

In one or more embodiments, the strengthening process may include any one or combinations of a thermal strengthening process, a chemical strengthening process and a mechanical strengthening process. In some embodiments, the strengthened glass sheet may be thermally strengthened by heating the glass to a temperature above the glass transition point and then rapidly quenching. In some embodiments, the strengthened glass sheet may be mechanically strengthened by utilizing a mismatch of the coefficient of thermal expansion between portions of the sheet to create a compressive stress region and a central region exhibiting a tensile stress.

In one or more embodiments, the glass sheet may be chemically strengthened by ion exchange. In the ion exchange process, ions at or near the surface of the glass sheet are replaced by—or exchanged with—larger ions having the same valence or oxidation state. In embodiments in which the glass sheet comprises an alkali aluminosilicate glass, ions in the surface layer of the glass sheet and the larger ions are monovalent alkali metal cations, such as Li+, Na+, K+, Rb+, and Cs+. Alternatively, monovalent cations in the surface layer may be replaced with monovalent cations other than alkali metal cations, such as Ag+ or the like. In such embodiments, the monovalent ions (or cations) exchanged into the glass sheet generate a stress. It should be understood that any alkali metal oxide containing glass sheet can be chemically strengthened by an ion exchange process.

Ion exchange processes are typically carried out by immersing a glass sheet in a molten salt bath (or two or more molten salt baths) containing the larger ions to be exchanged with the smaller ions in the inner glass ply. It should be noted that aqueous salt baths may also be utilized. In addition, the composition of the bath(s) may include more than one type of larger ion (e.g., Na+ and K+) or a single larger ion. It will be appreciated by those skilled in the art that parameters for the ion exchange process, including, but not limited to, bath composition and temperature, immersion time, the number of immersions of the inner glass ply in a salt bath (or baths), use of multiple salt baths, additional steps such as annealing, washing, and the like, are generally determined by the composition of the glass sheet and the desired DOC and CS of the glass sheet that results from strengthening. Exemplary molten bath composition may include nitrates, sulfates, and chlorides of the larger alkali metal ion. Typical nitrates include KNO3, NaNO3, LiNO3, NaSO4 and combinations thereof. The temperature of the molten salt bath typically is in a range from about 380° C. up to about 450° C., while immersion times range from about 15 minutes up to about 100 hours depending on glass sheet thickness, bath temperature and glass (or monovalent ion) diffusivity. However, temperatures and immersion times different from those described above may also be used.

In one or more embodiments, the glass sheet may be immersed in a molten salt bath of 100% NaNO3, 100% KNO3, or a combination of NaNO3 and KNO3 having a temperature from about 370° C. to about 480° C. In some embodiments, the glass sheet may be immersed in a molten mixed salt bath including from about 1% to about 99% KNO3 and from about 1% to about 99% NaNO3. In one or more embodiments, the glass sheet may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass sheet may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass sheet. The spike may result in a greater surface CS value. This spike can be achieved by single bath or multiple baths, with the bath(s) having a single composition or mixed composition, due to the unique properties of the glass compositions used in the glass sheet described herein.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass sheet. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from Glasstress Ltd., located in Tallinn, Estonia), depending on the strengthening method and conditions. When the glass sheet is chemically strengthened by an ion exchange treatment, FSM or SCALP may be used depending on which ion is exchanged into the glass sheet. Where the stress in the glass sheet is generated by exchanging potassium ions into the glass sheet, FSM is used to measure DOC. Where the stress is generated by exchanging sodium ions into the glass sheet, SCALP is used to measure DOC. Where the stress in the glass sheet is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass sheet is measured by FSM. Central tension or CT is the maximum tensile stress and is measured by SCALP.

In one or more embodiments, the glass sheet maybe strengthened to exhibit a DOC that is described a fraction of the thickness t of the glass sheet (as described herein). For example, in one or more embodiments, the DOC may be equal to or greater than about 0.05 t, equal to or greater than about 0.1 t, equal to or greater than about 0.11 t, equal to or greater than about 0.12 t, equal to or greater than about 0.13 t, equal to or greater than about 0.14 t, equal to or greater than about 0.15 t, equal to or greater than about 0.16 t, equal to or greater than about 0.17 t, equal to or greater than about 0.18 t, equal to or greater than about 0.19 t, equal to or greater than about 0.2 t, equal to or greater than about 0.21 t. In some embodiments, The DOC may be in a range from about 0.08 t to about 0.25 t, from about 0.09 t to about 0.25 t, from about 0.18 t to about 0.25 t, from about 0.11 t to about 0.25 t, from about 0.12 t to about 0.25 t, from about 0.13 t to about 0.25 t, from about 0.14 t to about 0.25 t, from about 0.15 t to about 0.25 t, from about 0.08 t to about 0.24 t, from about 0.08 t to about 0.23 t, from about 0.08 t to about 0.22 t, from about 0.08 t to about 0.21 t, from about 0.08 t to about 0.2 t, from about 0.08 t to about 0.19 t, from about 0.08 t to about 0.18 t, from about 0.08 t to about 0.17 t, from about 0.08 t to about 0.16 t, or from about 0.08 t to about 0.15 t. In some instances, the DOC may be about 20 μm or less. In one or more embodiments, the DOC may be about 40 μm or greater (e.g., from about 40 μm to about 300 μm, from about 50 μm to about 300 μm, from about 60 μm to about 300 μm, from about 70 μm to about 300 μm, from about 80 μm to about 300 μm, from about 90 μm to about 300 μm, from about 100 μm to about 300 μm, from about 110 μm to about 300 μm, from about 120 μm to about 300 μm, from about 140 μm to about 300 μm, from about 150 μm to about 300 μm, from about 40 μm to about 290 μm, from about 40 μm to about 280 μm, from about 40 μm to about 260 μm, from about 40 μm to about 250 μm, from about 40 μm to about 240 μm, from about 40 μm to about 230 μm, from about 40 μm to about 220 μm, from about 40 μm to about 210 μm, from about 40 μm to about 200 μm, from about 40 μm to about 180 μm, from about 40 μm to about 160 μm, from about 40 μm to about 150 μm, from about 40 μm to about 140 μm, from about 40 μm to about 130 μm, from about 40 μm to about 120 μm, from about 40 μm to about 110 μm, or from about 40 μm to about 100 μm.

In one or more embodiments, the strengthened glass sheet may have a CS (which may be found at the surface or a depth within the glass sheet) of about 200 MPa or greater, 300 MPa or greater, 400 MPa or greater, about 500 MPa or greater, about 600 MPa or greater, about 700 MPa or greater, about 800 MPa or greater, about 900 MPa or greater, about 930 MPa or greater, about 1000 MPa or greater, or about 1050 MPa or greater. In one or more embodiments, the strengthened glass sheet may have a CS (which may be found at the surface or a depth within the glass sheet) from about 200 MPa to about 1500 MPa, from about 250 MPa to about 1500 MPa, from about 300 MPa to about 1500 MPa, from about 350 MPa to about 1500 MPa, from about 400 MPa to about 1500 MPa, from about 450 MPa to about 1500 MPa, from about 500 MPa to about 1500 MPa, from about 550 MPa to about 1500 MPa, from about 600 MPa to about 1500 MPa, from about 200 MPa to about 1400 MPa, from about 200 MPa to about 1300 MPa, from about 200 MPa to about 1200 MPa, from about 200 MPa to about 1100 MPa, from about 200 MPa to about 1050 MPa, from about 200 MPa to about 1000 MPa, from about 200 MPa to about 950 MPa, from about 200 MPa to about 900 MPa, from about 200 MPa to about 850 MPa, from about 200 MPa to about 800 MPa, from about 200 MPa to about 750 MPa, from about 200 MPa to about 700 MPa, from about 200 MPa to about 650 MPa, from about 200 MPa to about 600 MPa, from about 200 MPa to about 550 MPa, or from about 200 MPa to about 500 MPa.

In one or more embodiments, the strengthened glass sheet may have a maximum tensile stress or central tension (CT) of about 20 MPa or greater, about 30 MPa or greater, about 40 MPa or greater, about 45 MPa or greater, about 50 MPa or greater, about 60 MPa or greater, about 70 MPa or greater, about 75 MPa or greater, about 80 MPa or greater, or about 85 MPa or greater. In some embodiments, the maximum tensile stress or central tension (CT) may be in a range from about 40 MPa to about 100 MPa, from about 50 MPa to about 100 MPa, from about 60 MPa to about 100 MPa, from about 70 MPa to about 100 MPa, from about 80 MPa to about 100 MPa, from about 40 MPa to about 90 MPa, from about 40 MPa to about 80 MPa, from about 40 MPa to about 70 MPa, or from about 40 MPa to about 60 MPa.

In one or more embodiments, the vehicle includes the combination of a windshield laminate (including a first annealed glass sheet, an interlayer disposed on the first annealed glass sheet, and a second strengthened glass sheet disposed on the interlayer opposite the first annealed glass sheet), and a side window laminate (including a third annealed glass sheet adjacent the interior, an interlayer disposed on the third annealed glass sheet, and a fourth strengthened glass sheet disposed on the interlayer opposite the third annealed glass sheet). In one or more embodiments, the first annealed glass sheet (of the windshield laminate) has a thickness in a range from about 1.5 mm to about 2.5 mm and the second strengthened glass sheet (of the windshield laminate) comprises a thickness in a range from about 0.7 mm to about 2.5 mm, and the third third annealed glass sheet (of the side window laminate) comprises a thickness in a range from about 1.5 mm to about 2.5 mm, and the fourth strengthened glass sheet (of the side window laminate) comprises a thickness in a range from about 0.5 mm to about 2.5 mm.

In one or more embodiments, the first annealed glass sheet and the second strengthened glass sheet (of the windshield laminate) have a thickness of about 2.1 mm, the third annealed glass sheet (of the side window laminate) has a thickness of about 1.8 mm and the fourth strengthened glass sheet (of the side window laminate) has a thickness of about 0.7 mm.

In one or more embodiments, the interlayer disposed between the glass sheets of the laminate is a polymer interlayer. In one or more embodiments the interlayer may include any one or more of polyvinyl butyral (PVB), ethylene-vinyl acetate copolymer (EVA), thermoplastic urethane (TPU), polyvinyl chloride, ionomer (SentryGlas®), acrylic, thermoplastic elastomer (TPE). In one or more embodiments, the interlayer comprises a tri-layer interlayer having a total thickness in a range from about 0.76 mm to 0.84 mm, wherein the tri-layer comprises two outer layers each having of thickness in a range from about 0.30 mm to 0.37 mm, and an acoustic damping core layer having a thickness in a range from about 0.08 mm to 0.15 mm. In the disclosed examples the interlayer resin was acoustic PVB from the Saflex Division of Eastman Chemical Co., under the product name QE51. QE51 is a coextruded tri-layer having a total thickness of 0.81 mm with two outer skin layers each having a thickness of 0.34 mm and a relatively soft acoustic damping core layer having a thickness of 0.13 mm.

In one or more embodiments, the windshield can be, for example, a glass-resin-glass laminate comprising: an outer glass of an annealed soda lime glass; a resin of a polyvinyl butyral (PVB) thermoplastic adhesive interlayer; and an inner strengthened glass.

In embodiments, vehicle has a combination of a windshield laminate with a first glass sheet (exterior) with a thickness in a range from 1.8 mm to about 2.5 mm, and a second glass sheet (interior) with a thickness from about 0.7 mm to about 2.5 mm (i.e., from 2.5/2.5 to 1.8/0.7), and a side window laminate having a third glass sheet (exterior) with a thickness from 1.8 mm to about 2.1 mm, and a fourth glass sheet (interior) with a thickness from 0.7 mm to 2.1 mm (i.e., from 2.1/2.1 to 1.8/0.7).

In one or more embodiments, the side window laminate has a first glass sheet with a thickness in a range from 1.8 mm to 2.5 mm and a second glass sheet that is strengthened (e.g., chemically) with a thickness in a range from 0.5 mm to 0.7 mm (e.g., from 1.8/0.7 to 2.5/0.5). In one or more embodiments, the side window laminate has a first glass sheet unstrengthened with a thickness in a range from 1.6 mm to 2.5 mm and a second glass sheet that is unstrengthened (e.g., chemically) with a thickness in a range from 1.6 mm to 2.5 mm (e.g., from 1.6/1.6 to a 2.5/2.5).

In embodiments, the side window laminate can be, for example, a 1.8/0.7 to 2.1/0.7 with the thin sheet including a chemically strengthened aluminosilicate glass to a 2.1/2.1 unstrengthened soda lime silicate laminate.

In embodiments, the vehicle can include, for example, a driver or drivers, a passenger or passengers, or a combination thereof.

In embodiments, the vehicle can be, for example, driverless, passenger-less, or both.

In embodiments, the vehicle can include, for example, one or more driver, one or more passenger, or no passengers or no driver whatsoever, for example, as in an occupied or unoccupied autonomous operation.

In embodiments, the occupant cabin can be occupied or unoccupied depending upon the operation.

In embodiments, the cabin can include at least one forward facing windshield laminate, and at least a pair of side window laminates. In embodiments, the at least one windshield laminate, and at least a pair of side window laminates can be separable and distinct window components, and optionally having an A-pillar separating adjacent window components. In embodiments, the at least one windshield laminate, and at least a pair of side window laminates can be a single laminate piece or continuous laminate structure having appropriate out-of-plane contours in each window area, and out-of-plane bends forming the side facing windows and without an A-pillar separation structure. The single laminate piece or continuous laminate structure can have separate out-of-plane contours, e.g., for 0 to 30 degrees, for the respective windshield laminate and side window laminates, and additionally out-of-plane bends, e.g., for 30 to 90 degrees, to form the side facing window portions from the main windshield portion.

A second aspect of this disclosure pertains to a method for reducing cabin noise that includes minimizing the above-mentioned coincidence effect by, for example, selecting a combination of glazing constructions or structures where the respective coincidence dip frequencies of the structures are different and cancel each other out. In one or more embodiments, the present disclosure provides a method of making (i.e., selection rules for) laminate window structures that produce a windshield having a coincidence dip and a pair of front side windows having coincidence dips that occur at different frequencies different from that of the windshield and achieve a net reduction in transmitted sound or an equivalence in transmitted sound, and with reduced weight compared to conventional vehicles.

In embodiments, the present disclosure provides a method of making wherein the net amount of sound energy transmitted into a vehicle cabin through the windshield and the front side windows can be reduced by selecting a combination of windshield and side window laminate structures such that the respective coincidence dips of the windshield and the front side windows are separated in frequency by, for example, at least one one-sixth (⅙) octave band. The weight of the combined windshield and front side glass components can be reduced with little acoustic penalty if the windshield and front side glass laminate constructions are selected such that their respective coincidence dips occur at different frequencies.

In embodiments, the disclosure provides a method of making vehicle window configurations and a method of using the vehicle window configurations that have offsetting coincidence frequencies of the windshield and front side windows. The disclosed configurations can reduce exterior sound transmission into the vehicle relative to configurations where the coincidence dips occur over the same or similar frequency ranges.

In embodiments, the disclosure provides a method of reducing cabin noise in a vehicle comprising: outfitting the vehicle with the forward facing windshield, and at least a pair of front side facing windows (i.e., distinguished from the rear side facing windows) wherein the vehicle has an occupant cabin defined by a combination of at least a forward facing windshield, and at least a pair of front side facing windows adjacent, or proximal, to the windshield, wherein the windshield is a glass-resin-glass laminate, and the side facing windows are each identical glass-resin-glass laminates; and the combination has a coincidence dip of minimum frequencies, and the coincidence dips are offset by from one to two ⅓ octave intervals.

In embodiments, the method can further comprise operating the vehicle, for example, manually, remotely, or autonomously.

In embodiments, the vehicle can be, for example, stationary or in motion while operating.

In one or more embodiments, the method of making a vehicle includes installing a forward facing windshield laminate structure, and at least a pair of front side facing window laminates in a vehicle cabin, wherein the windshield laminate structure has a first coincident dip minimum at a first frequency, and the pair of front side windows has a second coincident dip minimum at a second frequency, and the respective coincidence dip minima (or the first and second frequencies) are offset by at least one one-sixth octave interval.

In embodiments, the method, prior to installing, can further comprise modeling at least one of a combination of the forward-facing windshield laminate structure and at least a pair of front side facing windows laminate structures, and selecting at least one of the modeled combinations that has the first and second coincidence dip minima offset by at least one one-sixth octave interval.

In embodiments, each laminate structure can be, for example, a glass-resin-glass laminate, and the coincidence dip minima are offset by of from one-half to six one-third octave intervals.

In embodiments, the windshield has a laminate structure of 1.5/1.5 WS, and each front side facing window has a laminate structure of 2.5/0.5 FS.

In one or more embodiments, a method of reducing vehicle cabin noise includes installing a windshield laminate, and at least a pair of front side window laminates in a vehicle cabin, wherein the windshield laminate has a first coincident dip minimum at a first frequency in a range from about 2500 Hz to about 8000 Hz, and the pair of front side facing windows laminate structure both have a second coincident dip minimum at a second frequency in the range from about 2500 Hz to about 8000 Hz, and wherein the first frequency and the second frequency differ by at least one one-sixth octave interval.

In one or more embodiments of the method of reducing vehicle cabin noise, the windshield laminate comprises a first glass sheet and a second glass sheet that differ in thickness and strength levels from one another, and the side window laminate comprises a third glass sheet and a fourth glass sheet that differ in thickness and strength levels. In one or more embodiments, the windshield laminate comprises a first glass sheet and a second glass sheet that differ in thickness and glass composition from one another, and the side window laminate comprises a third glass sheet and a fourth glass sheet that differ in thickness and glass composition from one another. In one or more embodiments, the windshield laminate and the side window laminates have a surface density that is substantially equal. In one example, the windshield laminate comprises a first annealed glass sheet, an interlayer disposed on the first annealed glass sheet, and a second strengthened glass sheet disposed on the interlayer opposite the first annealed glass sheet. The first annealed glass sheet can include a thickness in a range from about 1.5 mm to about 2.5 mm and the second strengthened glass sheet can include a thickness in a range from about 0.7 mm to about 2.5 mm The side window laminate may include a third annealed glass sheet adjacent the interior, an interlayer disposed on the third annealed glass sheet, and a fourth strengthened glass sheet disposed on the interlayer opposite the third annealed glass sheet. The third annealed glass sheet can comprise a thickness in a range from about 1.5 mm to about 2.5 mm, and the fourth strengthened glass sheet can comprise a thickness in a range from about 0.5 mm to about 2.5 mm.

In various embodiments described herein offer a reduced noise level sensed or measured within the vehicle cabin or within vehicle interiors arising from external airborne noise sources and also offer weight reduction of the windshield and front side glass combinations having comparable or superior cabin noise levels compared to heavier glass combinations, or both.

The disclosed examples below show how the interior sound level of a vehicle can be reduced by offsetting, in frequency, the coincidence dip minima of the combination of a windshield laminate and side window laminates. All the example results were obtained from modeling studies using SEAM statistical energy analysis software from Cambridge Collaborative. The measured frequency independent modulus and loss factors for the glass, and frequency dependent modulus and loss factors for the PVB interlayer were measured using dynamic mechanical analysis (DMA). DMA measurements were done using TA Instruments ARIES G2 rheometer.

Acoustic energy within a vehicle cabin can be characterized by the interior sound pressure level (SPL) in dB. A higher SPL means a noisier cabin.

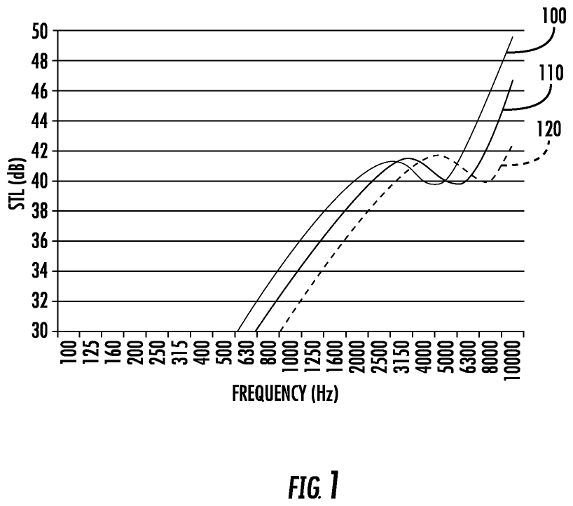

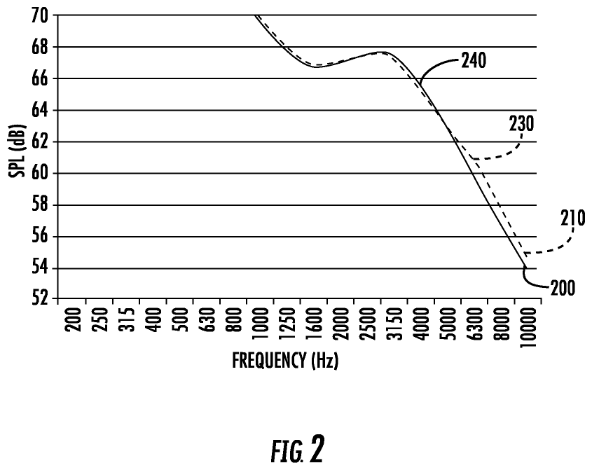

The examples in FIG. 2 (the combination of a windshield laminate and a side window laminate) show a comparison of a reference or baseline of the combination of a 2.0/2.0 windshield and a 2.0/2.0 front side window laminate (210) and a 2.5/2.5 windshield and 1.5/1.5 front side window laminate combination (200). The 210 combination has coincidence dip minima over identical frequency ranges (i.e., 5000 to 6300 Hz) so that combination exhibits an increase in interior sound pressure level relative to the 200 combination. In the 200 combination, the coincidence dip minima occur at from 4000 to 5000 Hz, and 8000 Hz, respectively (see FIG. 1) so the high STL of the 1.5/1.5 structure between 4000 to 5000 Hz compensates for the low STL of the 2.5/2.5 windshield resulting in a net lower SPL (240).

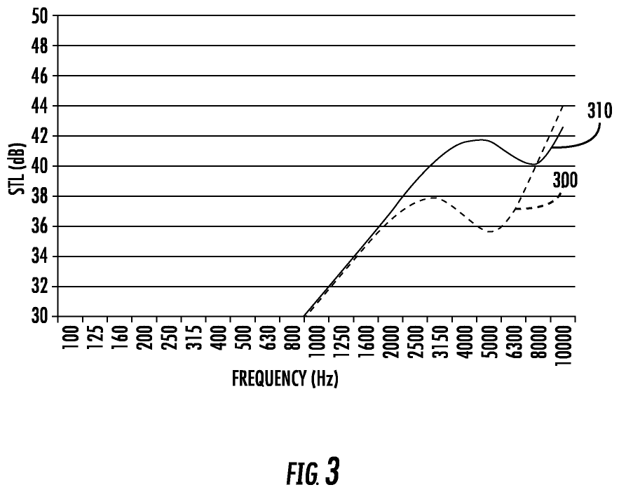

FIG. 3 compares the sound transmission loss for a 1.5/1.5 laminate windshield (310) construction and a 2.5/0.5 laminate windshield (300) construction. FIG. 3 shows the sound transmission loss of a 1.5/1.5 laminate windshield (310) is high in the coincidence frequency range of a 2.5/0.5 laminate windshield (300). Both of these constructions have the same surface density but their coincidence dip minima are widely separated such that the maximum sound transmission loss of the 1.5/1.5 laminate windshield occurs over the frequency range where the sound transmission loss is low for 2.5/0.5 laminate windshield construction. The sound transmission loss (STL) is a characteristic of a laminate construction, and is not specific to the windshield or the front side windows. These laminate constructions have the same surface densities and their coincidence dip minimum frequencies are separated by two ⅓ octave intervals.

The STL plot in FIG. 3 shows that the 1.5/1.5 laminate construction (310) has a much higher STL across the coincidence frequency range of the 2.5/0.5 laminate construction (300).

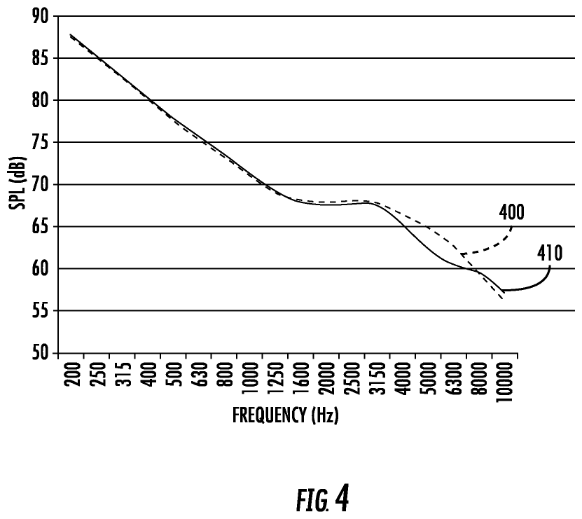

FIG. 4 shows the sound pressure level plots for a combination of a 2.5/0.5 windshield (WS) combined with a 2.5/0.5 front side window laminate (FS) (400), and 1.5/1.5 WS combined with a 2.5/0.5 FS (410). FIG. 4 compares SPL vs. frequency for the 400 combination and the 410 combination. This comparison illustrates the effect of substituting the 1.5/1.5 windshield construction in place of the 2.5/0.5 windshield. High STL of the 1.5/1.5 WS compensates for the low STL of the 2.5/0.5 front side windows in the 3150 to 6300 Hz range resulting in overall reduced SPL in the vehicle interior. This frequency range encompasses the region of most sensitive human hearing so reducing SPL in this frequency range has a large effect on reducing perceived loudness. Our modelling studies showed that excellent performance can be obtained by placing the most acoustically advantaged laminate, for example, a 1.5/1.5 laminate, in the largest area dominant glazing position, i.e., the windshield. FIG. 4 shows that the high STL of a 1.5/1.5 windshield compensates for a coincidence dip of a 2.5/0.5 windshield resulting in a lower sound pressure level when a 1.5/1.5 windshield is substituted for a 2.5/0.5 windshield. These laminate constructions have different surface densities and their coincidence dip minimum frequencies are separated by two ⅓ octave interval.

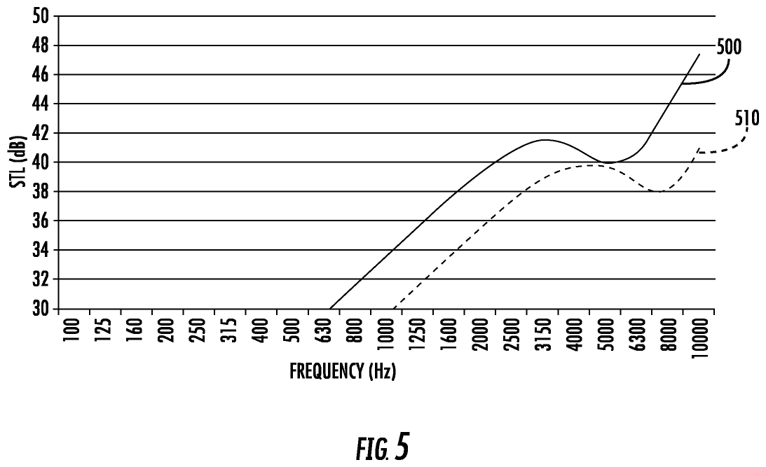

FIG. 5 shows laminate constructions where the respective coincidence dip minima are separated by two ⅓ octave bands. FIG. 5 shows sound transmission loss curves as a function of frequency for a 2.1/2.1 laminate (500), and 1.8/0.7 laminate (510) that have different surface densities and their coincidence dip minimum frequencies are separated by two ⅓ octave intervals. A 2.1/2.1 laminate construction was used in both windshield and front side windows, and the 1.8/0.7 laminate construction was used in front side windows in conjunction with a 2.1/2.1 windshield.

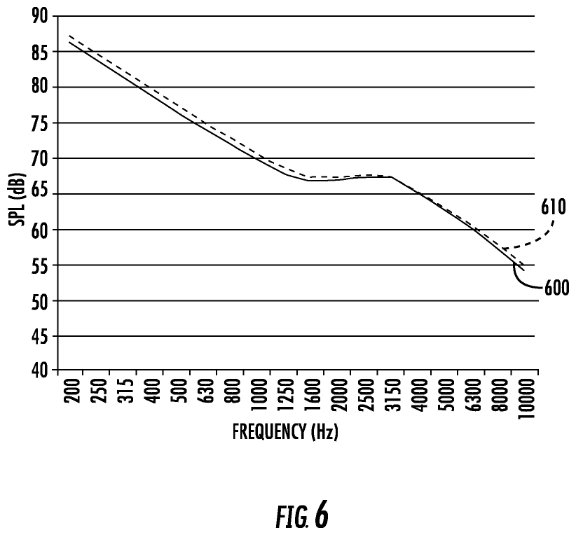

FIG. 6 is a comparison of sound pressure level plots for a combination of a 2.1/2.1 WS and 2.1/2.1 FS (600), and a combination of 2.1/2.1 WS and 1/8/0.7 FS (610), which illustrates that a weight savings can be achieved with a minimal acoustic penalty at frequencies above 1600 Hz when the coincidence dip minimum frequencies of WS and FS are separated by two ⅓ octave intervals. The results plotted in FIG. 6 show that the acoustic penalty in going to a lighter weight combination of a windshield and front side window is small in the frequency range most significant to human hearing (i.e., 1000 to 5000 Hz).

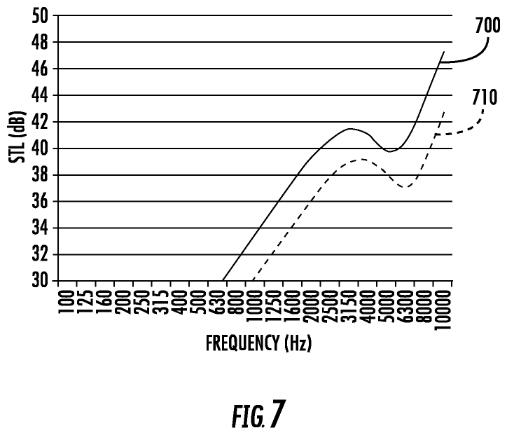

FIG. 7 shows the sound transmission loss for a laminate construction where the respective coincidence dip minima are separated by one ⅓ octave band. FIG. 7 shows the sound transmission loss curves as a function of frequency for a 2.1/2.1 laminate (700), and a 2.1/0.7 (with a thin, chemically strengthened glass sheet with thickness 0.7 mm) (710) that have different surface densities and their coincidence dip minimum frequencies are separated by one ⅓ octave interval. The 2.1/2.1 laminate construction was used in the windshield position, and the 2.1/0.7 laminate was used as front side windows in conjunction with a 2.1/2.1 windshield.

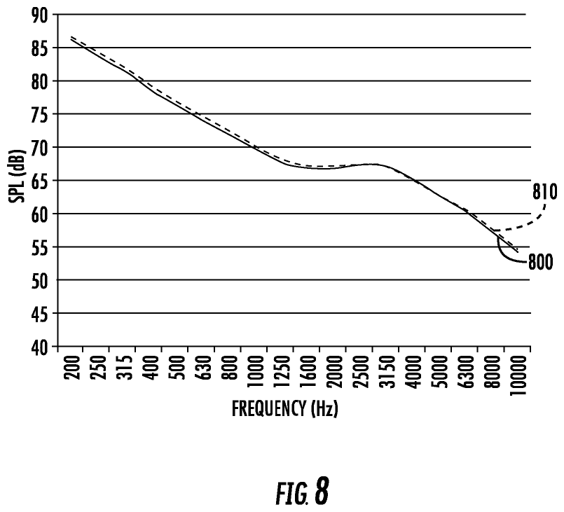

FIG. 8 shows a comparison of the sound pressure level plots for a combination of a 2.1/2.1WS and 2.1/2.1 FS laminate (800), and a combination of 2.1/2.1WS and 2.1/0.7 FS laminate (810), which illustrates that a weight savings can be achieved with minimal acoustic penalty when the coincidence dip minimum frequencies of WS and FS laminate combination are separated by one ⅓ octave interval such as shown in FIG. 7.

The examples in FIGS. 5, 6, 7, and 8 show that significant weight savings, for example, of from 10 to 20 percent, of from 12 to 18 percent, of from 13 to 17 percent, and like savings, including intermediate values and ranges, can be achieved by using windshield and front side laminates of different surface densities and separated in frequency by one or two ⅓ octave bands. Table 1 is a tabulation of the change in SPL (dB) resulting from substitution of a lighter weight hybrid laminate windshield and front side window combination relative to a reference baseline of a 2.1/2.1 windshield and 2.1/2.1 front side windows (i.e., a control configuration of 2.1/2.1 WS and 2.1/2.1 FS).

Specifically, Table 1 tabulates changes in interior sound pressure level and weight reduction for front side window laminate substitutions of: a 2.1/0.7 hybrid front side window laminate (with 0.7 mm-thick chemically strengthened aluminosilicate glass sheet); and a 1.8/0.7 hybrid front side window laminate (with 0.7 mm-thick chemically strengthened aluminosilicate glass sheet), relative to a reference baseline of a 2.1/2.1 windshield and a 2.1/2.1 front side glass window combination (i.e., the control configuration of 2.1/2.1 WS and 2.1/2.1 FS). A “delta means increase” refers to the increase in the vehicle interior SPL for front side glass window substitution examples relative to the baseline combination (i.e., the control configuration of a 2.1/2.1 WS and 2.1/2.1 FSW). The results for the disclosed configurations or combinations show that the dB decreases and the weight decreases relative to the control.

In one or more embodiments, for a combination of 1.5/1.5 WS and 2.1/0.5 FS relative to a combination of a 2.1/2.1 WS and 2.1/2.1 FS combination (control) there is a 1.7 dB penalty at 800 Hz and 2.3 dB at 8000 Hz. However, there is a 0.2 dB improvement at 5000 Hz, within the range of most sensitive hearing. The penalty based on average dB between 1000 to 5000 Hz is 0.7 dB. The weight savings for the combination of a 1.5/1.5 WS and 2.1/0.5 FS relative to 2.1/2.1 WS and 2.1/2.1 FS is 30%. In such embodiments, the coincident dip minima offset is at about one one-third octave interval.

In a more specific embodiment, for a combination of a 2.1/2.1 WS and a 1.8/0.7 FS relative to a combination of 2.1/2.1 WS and 2.1/2.1 FS (control) there was a 0.9 dB penalty at 800 Hz and 0.5 dB penalty at 8000 Hz, and only a 0.2 dB penalty at 5000 Hz, within the range of most sensitive hearing. The penalty based on average dB between 1000 to 5000 Hz is 0.4 dB. These acoustic penalties are small compared to the approximately 3 dB change in SPL required to produce a perceptible change in loudness. The 2.1/2.1/WS 1.8/0.7 FS combination affords a 16% weight saving compared to the 2.1/2.1 WS 2.1/2.1 FS baseline. A positive difference in the SPL compared to the control means an increase in the SPL. In the more specific embodiment, the coincident dip minima offset is at about two one-third octave intervals.

TABLE 1
Difference in SPL values obtained for Gorilla Glass ® hybrid
windshield and front side glass window substitution examples.

| | | | | | 2.1/2.1 WS | |
|---|---|---|---|---|---|---|
| | 2.1/2.1 WS | 2.1/2.1 WS | | 1.5/1.5 WS | and | |
| | and | and | | and | 2.1/2.1 FS | |
| | 1.8/0.7 FS | 2.1/0.7 FS | | 2.1/0.5 FS | (control) | |
| 800 Hz | 0.9 dB | 0.7 | dB | 1.7 dB | 71.9 | dB |
| 5000 Hz | 0.2 dB | 0.2 | dB | −0.2 | 62.7 | dB |
| 8000 Hz | 0.6 dB | 0.5 | dB | 2.3 | 57.3 | dB |
| Average 1000 | 0.4 dB | 0.31 | dB | 0.7 dB | 66.7 | dB |
| to 5000 Hz | | | | | | |

| | | | | | |
|---|---|---|---|---|---|
| WS + FS wt. | 16% | 13% | 30% | 28.0 | kg |
| reduction % relative | | | | | |
| to control/baseline | | | | | |

The inventive examples in Table 1 illustrate the use of glass laminates having an acoustic PVB interlayer in a vehicle cabin configuration. Laminated glass using standard, non-acoustic, PVB can also be used where the coincidence dip minimum frequency can be adjusted by the glass thickness and symmetry ratio discussed above. In addition, different thicknesses of PVB may be used. In embodiments, laminated glass structures having, for example, ethyl vinyl alcohol (EVA), ionomer, polyethylene, or any effective interlayer material is suitable. In embodiments, combinations of different interlayer materials in laminated glass constructions are contemplated.

The separation of the coincidence dip minimum frequencies between any set of glass components is not limited to multiples of ⅓ octave bands, but includes any separation of frequencies that effectively reduce interior sound pressure level for example, a separation by one 1/16 octave band or more.

The following mentions windshield and front side window dimensions that were modeled. The vehicle cabin interior dimensions and acoustic absorption were constant for all models:

Windshield (WS) sizes were from 1.17 to 1.44 m²;
Front side glass (FS) sizes were from 0.25 to 0.42 m²; and
Cabin airspace dimensions were constant for all window combination modeling: L=2200 mm; W=700 mm; and H=1100 mm

The time for the SPL of a sound pulse within a vehicle cabin to decrease by 60 dB (“T60”) was used to define interior cabin sound absorption and was constant for all models. T60 is a function of frequency as indicated in Table 2.

TABLE 2
SPL diminution with cabin absorption.

| Frequency (Hz) | Time (mS) |
|---|---|
| 3150 | 95 |
| 4000 | 100 |
| 5000 | 110 |
| 6300 | 170 |
| 8000 | 250 |
| 10000 | 250 |

The non-glazing acoustic flanking paths were characterized by sound transmission loss vs. frequency that follows the mass law. Ranges of sound transmission loss used for flanking are listed in Table 3.

TABLE 3

| Frequency (Hz) | STL ranges (dB) |
|---|---|
| 3150 | 27-48 |
| 4000 | 29-50 |
| 5000 | 31-52 |
| 6300 | 33-54 |
| 8000 | 35-56 |
| 10000 | 37-58 |

The trends in SPL with the disclosed windshield and front side window combinations were not significantly affected by flanking.

### EXAMPLES

The following Examples demonstrate making, use, and analysis of the disclosed vehicle window configurations and methods in accordance with the above general procedures.

The results provided in the following Examples were obtained using validated finite elements models for laminated glass stiffness and damping properties (based on glass and PVB interlayer modulus and damping properties). The interior vehicle sound pressure level (SPL) was calculated using validated statistical energy analysis models where the laminate stiffness and damping were inputs.

It was found that the preparation of hybrid laminates with a chemically strengthened thin, aluminosilicate glass sheet is best accomplished using industry standard lamination techniques. Industry standard lamination methods were used to prepare the disclosed vehicle laminated glass windows that were used in the disclosed model validation studies.

In the examples below SPL refers to interior vehicle sound pressure level that was calculated using a validated statistical energy analysis model (SEAM®) software from Cambridge Collaborative, Inc., Golden, Colo.

### Example 1

Reduced interior vehicle SPL obtained by offsetting windshield and front side glass coincidence dip minima by adjusting glass thickness The frequency and depth of the coincidence dip of a laminate depends on the laminate's stiffness and damping. Stiffness, which is determined by interlayer modulus, glass thickness, and the relative difference in glass thickness of the individual plies (referred to as thickness symmetry), determines the coincidence dip frequency. Damping, which is determined by an interlayer loss factor and a modulus, determines the coincidence dip depth. To minimize the depth of the coincidence dip, a highly damping acoustic grade of PVB was selected. In this example a commercially available acoustic PVB (Eastman QE51) was used as the interlayer.

In a vehicle the largest sources of transmitted noise are the windshield and front side windows. Each of these windows act as a band pass filter transmitting a significant amount of noise in the coincidence frequency range. If the coincidence dip minima of the windshield and the front side windows coincide in frequency then the noise transmitted across the coincidence dip frequency range will be enhanced. If the coincidence dip frequencies are offset such that the sound transmission loss of one of either of the windshield or the front side windows is at a high value while the other is a low value then transmitted noise will be reduced.

Referring to the figures, FIG. 1 is a sound transmission loss plot (sound transmission loss (STL) v. frequency) that shows coincidence dip frequency ranges and STL plots for individual window structures, i.e., a component level analysis. FIG. 1 shows the coincidence dip minimum frequency of a 2.5/2.5 laminate is 4000 Hz, the coincidence dip minimum frequency for a 1.5/1.5 window is 8000 Hz, which is a separation of two ⅓ octave intervals. Each hash mark or increment on the x-axis represents a one third octave. In isolation, the coincidence dip minimum frequencies of the 2.0/2.0 windshield and 2.0/2.0 front side window laminates are the same. In this example coincidence frequencies were offset using different individual window structures, that is, different glass laminate thicknesses. The frequency of coincidence dip minimum varies inversely with stiffness so a thicker, symmetric, stiffer, laminate will have a lower coincidence dip minimum frequency than a thinner, symmetric, less stiff, laminate.

A first structure 1 is a laminate sandwich having a 2.5 mm annealed soda lime glass exterior, a 0.8 mm thick commercial acoustic resin (PVB), and a 2.5 mm annealed soda lime glass interior, i.e., a “2.5/2.5” structure (100);

A second structure 2 is a laminate sandwich having a 2.0 mm annealed soda lime glass exterior, a 0.8 mm thick commercial acoustic resin (PVB), and a 2.0 mm annealed soda lime glass interior, i.e., a “2.0/2.0” structure (110); and

A third structure 3 is a laminate sandwich having a 1.5 mm annealed soda lime glass exterior, a 0.8 mm thick commercial acoustic resin (PVB), and a 1.5 mm annealed soda lime glass interior, i.e., a “1.5/1.5” structure (120).

Proper selection of individual windshield and front side glass laminate components when properly combined for vehicle cabin use can reduce the sound pressure level (SPL).

In FIG. 2 the SPL of a combination of a 2.5/2.5 windshield laminate and 1.5/1.5 front side window laminates (i.e., a 2.5/2.5 windshield 1.5/1.5 front side windows; i.e., 2.5/2.5 WS 1.5/1.5 FS) were compared with a 2.0/2.0 windshield laminate combined with a pair of 2.0/2.0 front side windows (i.e., 2.0/2.0 WS 2.0/2.0 FS). The windshield/front side window combination structures and modeling their SPL is a systems level analysis, i.e., simulating a cabin vehicle environment with an occupant.

FIG. 2 shows a lower sound pressure level (SPL) at about the driver's ear for a combination of a 2.5/2.5 laminate windshield and 1.5/1.5 front side windows that results when coincidence dip minima are off-set in frequency compared to the situation where both windshield and front side windows are 2.0/2.0 laminates where the coincidence dip minima of windshield and front side windows occur at the same frequency (see FIG. 1). The total glass-resin-glass laminate (i.e., windshield and front-side glass) thickness was 9.6 mm in both instances shown in FIG. 2. The total glass thickness was 8 mm and the total resin thickness was 1.6 mm.

FIG. 2 also shows the effect on the sound pressure level (SPL) of separating coincidence dip minimum frequencies of the windshield and the front side windows by two ⅓ octave intervals while the keeping total laminate thickness and total weight the same, i.e., the same surface density, and coincidence dip minimum frequencies separated by two ⅓ octave bands.

FIG. 2 shows the sound pressure level plots for two different windshield and front side window combinations:

a 2.5/2.5 windshield (WS) combined with 1.5/1.5 front side (FS) windows (200) (i.e., 2.5/2.5 WS and 1.5/1.5 FS combination); and

a 2.0/2.0 windshield combined with 2.0/2.0 front side windows (210) (i.e., 2.0/2.0 WS and 2.0/2.0 FS combination).

An increase in the sound pressure level above 4000 Hz caused by a 2.0/2.0 WS and a 2.0/2.0 FS combination is due to the coincidence dip minima in both windshield and front side windows (230). This increase in the sound pressure level occurs because the coincidence dip minima of the 2.0/2.0 windshield and front side windows are at the same frequency.

An increase in the sound pressure level between 3150 Hz and 4000 Hz caused by a 2.5/2.5 windshield laminate is reduced because of the maximum sound transmission loss of a 1.5/1.5 front side window (240) in the 2.5/2.5WS and 1.5/1.5FS combination.

Results plotted in FIG. 2 show that the SPL of the 2.5/2.5 windshield combined with 1.5/1.5 front side windows is substantially the same as the 2.0/2.0 windshield combined with 2.0/2.0 front side windows up to 5000 Hz. However, above 5000 Hz the 2.5/2.5 windshield combined with 1.5/1.5 front side windows has about a 1 dB lower SPL than the 2.0/2.0 windshield combined with 2.0/2.0 front side windows. A lower SPL for a combination where the coincidence dip minimum frequencies were offset by two ⅓ octave intervals indicates that the total sound transmission through the combined windshield and front side windows is less than the combination where the coincidence dip frequencies are the same.

### Example 2

Reduced Interior Vehicle SPL Obtained by Offsetting Windshield and Front Side Glass Coincidence Dip Minima by Adjusting Glass Thickness and Glass Symmetry Ratio

Example 1 was repeated with the exception that the frequencies of the coincidence dip minima were adjusted by varying laminate stiffness using glass thickness and glass ply symmetry ratios, so that the coincidence dip minima differed by two ⅓ octave intervals as shown in FIG. 3. FIG. 3 shows the sound transmission loss (STL) curves of 1.5/1.5 and 2.5/0.5 laminate constructions. Their coincidence dip minima are separated by two ⅓ octave intervals. Results in FIG. 4 show that that by offsetting the coincidence dip minimum frequencies, the SPL was substantially reduced for the 1.5/1.5 windshield and 2.5/0.5 front side window combination relative to a 2.5/0.5 windshield and 2.5/0.5 front side combination between 4000 and 6300 Hz. For the latter combination the coincidence dip minima for the windshield and front side windows were at the same frequency.

The total laminate weight of the windshield and front side window for the 2.5/0.5 windshield and 2.5/0.5 front side window combination was 20.52 kg. The total laminate weight of windshield and front side windows for the 1.5/1.5 windshield and the 2.1/0.5 front side window combination was 20.57 kg. Thus, the reduction in SPL was from about 2.3 dB at 5000 Hz by offsetting coincidence dip minimum frequencies was achieved with a negligible (0.2%) increase in weight.

### Example 3

Weight Savings with Minimal Acoustic Penalty Obtained by Offsetting Coincidence Dip Minimum Frequencies by Two ⅓ Octave Intervals.

FIG. 6 shows a comparison between a combination of a 2.1/2.1 windshield and 2.1/2.1 front side windows, where the windshield and front side coincidence dip minimum frequencies are the same, and a more preferred combination of a 2.1/2.1 windshield and 1.8/0.7 front side windows, where the coincidence dip minimum frequencies are offset by two ⅓ octave intervals as shown in FIG. 5. Results plotted in FIG. 6 illustrate that significant weight savings or reductions, as mentioned above, can be achieved with minimal acoustic penalty in the frequency range from 1600 and 6300 Hz, which encompasses the frequency range of greatest sensitivity for human hearing. The total weight of the 2.1/2.1 windshield and 1.8/0.7 combination is 16% less that the baseline of the 2.1/2.1 windshield and the 2.1/2.1 front side window combination.

Referring to FIG. 6, the SPL of the 2.1/2.1 windshield and the 1.8/0.7 front side window combination (610) is greater than the baseline 2.1/2.1 WS 2.1/2.1 FS combination (600) below 1600 Hz. Although not limited by theory, this difference is a result of the mass law of sound transmission. In this mass controlled frequency range sound transmission loss depends solely on surface density of the laminated glass panels. The surface density of the 1.8/0.7 front side window structure is less than that of the 2.1/2.1 front side window structure of the comparative baseline. This difference results in a higher level of sound transmission, and consequently a higher interior vehicle cabin SPL at frequencies below 1600 Hz for the inventive 2.1/2.1 windshield and 1.8/0.7 front side combination. However, in the frequency range of greatest human hearing sensitivity, where laminate sound transmission properties can be engineered by proper selection of laminate stiffness and damping properties, there is a minimal difference in the transmitted sound and the interior vehicle SPL.

### Example 4

Weight Savings with Minimal Acoustic Penalty Obtained by Offsetting Coincidence Dip Minimum Frequencies by One ⅓ Octave Intervals

Example 3 was repeated except that the laminate stiffness is adjusted so that the offset in coincidence minimum frequencies is one ⅓ octave interval as shown in FIG. 7. FIG. 8 shows a SPL comparison between a combination of a 2.1/2.1 windshield and 2.1/2.1 front side window baseline, and a combination of a 2.1/2.1 windshield and 2.1/0.7 front side windows. Results plotted in FIG. 8 again illustrate that there is minimal increase SPL for the 13% lighter combination of a 2.1/2.1 windshield and 2.1/0.7 front side windows at 1600 Hz and above. The difference in the SPL between a combination of a 2.1/2.1 windshield and 2.1/0.7 front side window combination and baseline is smaller than in Example 3 below 1600 Hz. These results illustrate the trade-off between reduced weight savings relative to baseline and lower SPL in the mass controlled frequency range (below 1600 Hz).

### Example 5

Reduced Interior Vehicle SPL Obtained by Offsetting Windshield and Front Side Glass Coincidence Dip Minima by Adjusting Glass Symmetry Ratio

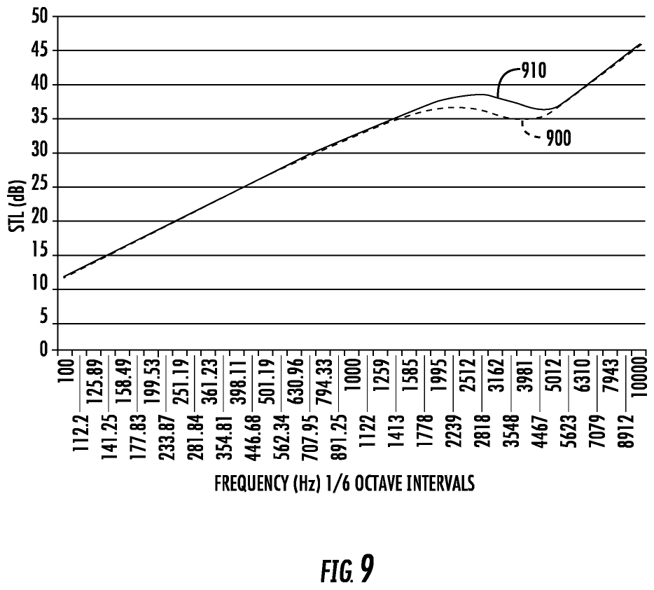

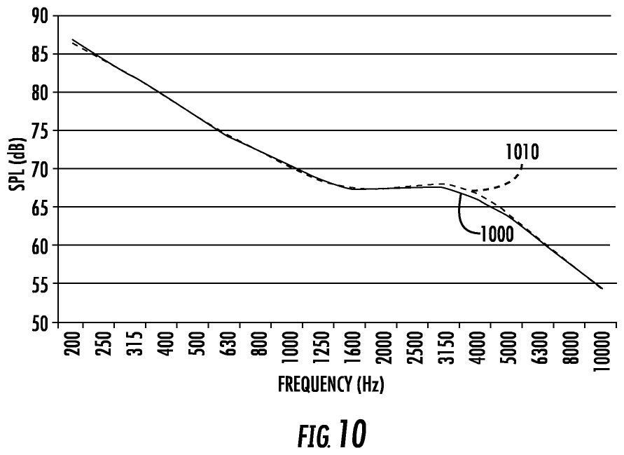

FIG. 9 shows STL vs. frequency plots in ⅙ octave bands for 3.2/0.55 and 2.9/0.9 laminate constructions. The coincidence dip minima of these two laminates differ by ⅙ octave band. FIG. 10 compares SPL vs. frequency for a full vehicle model for the example where both the windshield and the front side windows are 3.2/0.55 laminates, and the example where the windshield is 2.9/0.9 and front side windows are 3.2/0.55. Off-setting the coincidence dip minima by one ⅙ octave band between the windshield and front side windows results in a decrease in interior vehicle SPL at the driver's ear by 0.8 dB without any increase in weight.

### Example 6 (Prophetic)

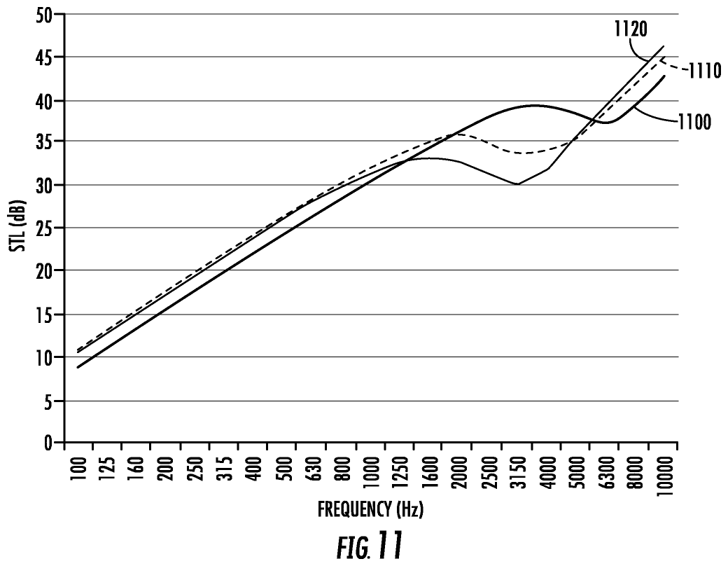

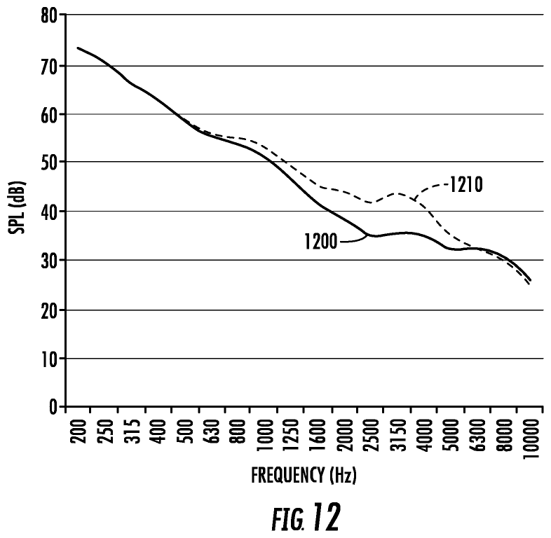

A windshield made with an acoustic PVB (APVB) interlayer and front side window made of a standard PVB (SPVB) interlayer is compared by modeling. The results were plotted in FIGS. 11 and 12.

FIG. 11 shows sound transmission loss plots for a 2.1/SPVB/1.6 laminate (1110), a 2.1/APVB/0.7 GG laminate (1100), and a 3.85 mm monolithic soda lime glass (1120). SPVB is standard non-acoustic PVB interlayer. Coincidence dip minimum frequencies are 3150 Hz for both 2.1/SPVB/1.6 and 3.85 mm monolithic glass. The coincidence dip minimum frequency for 2.1/0.6 is at 6300 Hz, which is three ⅓ octave intervals higher than the 2.1/SPVB/1.6.

FIG. 12 shows a full system model SPL v. frequency for a 2.1/SPVB/1.6 WS and 3.85 mm monolithic soda lime glass FS combination (1210), and a 2.1/SPVB/1.6 WS and 2.1/0.7 FS combination (1200). Shifting coincidence dip minimum frequencies of the front side windows three ⅓ octave intervals higher by replacing the 3.85 mm monolithic glass FS with a 2.1/0.7 laminates results in a reduction of the SPL by 7.8 dB at 3150 Hz.

Aspect (1) of this disclosure pertains to a vehicle comprising: a vehicle body enclosing an interior; a forward facing opening in communication with the interior; a windshield laminate having a first surface density (kg/m²) disposed in the forward facing opening; at least one side facing opening adjacent the forward facing opening; and a side window laminate having a surface density substantially equal to the first surface density disposed in the one side facing opening, wherein, within a frequency range from about 2500 Hz to about 8000 Hz, the windshield laminate comprises a first coincident dip minimum at a first frequency, and the side window laminate comprise a second coincident dip minimum at a second frequency, and wherein the first frequency and the second frequency differ by at least one one-sixth octave interval.

Aspect (2) of this disclosure pertains to the vehicle of Aspect (1), wherein the absolute difference between the first frequency and the second frequency differ by one half of one-third octave interval.

Aspect (3) of this disclosure pertains to the vehicle of Aspect (1) or Aspect (2), wherein the absolute difference between the first frequency and the second frequency is from one half to five one-third octave intervals.

Aspect (4) of this disclosure pertains to the vehicle of any one of Aspects (1) through (3), wherein the absolute difference between the first frequency and the second frequency is from one to two ⅓ octave intervals.

Aspect (5) of this disclosure pertains to the vehicle of any one of Aspects (1) through (4), wherein absolute difference between the first frequency and the second frequency is at least two ⅓ octave intervals.

Aspect (6) of this disclosure pertains to the vehicle of any one of Aspects (1) through (5), wherein one of or both the first frequency and the second frequency are less than 3000 Hz or greater than 5000 Hz.

Aspect (7) of this disclosure pertains to the vehicle of any one of Aspects (1) through (6), wherein the windshield laminate comprises a first annealed glass sheet, an interlayer disposed on the first annealed glass sheet, and a second strengthened glass sheet disposed on the interlayer opposite the first annealed glass sheet.

Aspect (8) of this disclosure pertains to the vehicle of any one of Aspects (1) through (7), wherein the side window laminate comprises a third annealed glass sheet adjacent the interior, an interlayer disposed on the third annealed glass sheet, and a fourth strengthened glass sheet disposed on the interlayer opposite the third annealed glass sheet.

Aspect (9) of this disclosure pertains to the vehicle of Aspect (7) or Aspect (8), wherein the first annealed glass sheet comprises a thickness in a range from about 1.5 mm to about 2.5 mm and the first strengthened glass sheet comprises a thickness in a range from about 0.7 mm to about 2.5 mm, and wherein third annealed glass sheet comprises a thickness in a range from about 1.5 mm to about 2.5 mm, and the fourth strengthened glass sheet comprises a thickness in a range from about 0.5 mm to about 2.5 mm.

Aspect (10) of this disclosure pertains to the vehicle of any one of Aspects (7) through (9), wherein the first annealed glass sheet and the second strengthened glass sheet have a thickness of about 2.1 mm, the third annealed glass sheet has a thickness of about 1.8 mm and the fourth strengthened glass sheet has a thickness of about 0.7 mm, wherein the vehicle, and wherein the difference between the first frequency and the second frequency is two ⅓ octave intervals or greater.

Aspect (11) of this disclosure pertains to the vehicle of any one of Aspects (7) through (10), wherein the interlayer comprises a tri-layer interlayer having a total thickness in a range from about 0.76 mm to 0.84 mm, wherein the tri-layer comprises two outer layers each having of thickness in a range from about 0.30 mm to 0.37 mm, and an acoustic damping core layer having a thickness in a range from about 0.08 mm to 0.15 mm.

Aspect (12) of this disclosure pertains to the vehicle of any one of Aspects (1) through (11), wherein the windshield laminate has a surface density in a range from about 7.3 kg/m² to 13.4 kg/m².

Aspect (13) of this disclosure pertains to the vehicle of any one of Aspects (1) through (12), wherein the vehicle is a driver or driverless vehicle selected from an automobile, a sport utility vehicle, a truck, a bus, a train, a watercraft, or an aircraft.

Aspect (14) of this disclosure pertains to the vehicle of any one of Aspects (1) through (13), further comprising a second side window laminate, wherein the windshield laminate is disposed between the side window laminates and is separated from each side window laminate by a pillar.

Aspect (15) of this disclosure pertains a method of reducing vehicle cabin noise comprising: installing a windshield laminate, and at least a pair of front side window laminates in a vehicle cabin, wherein the windshield laminate has a first coincident dip minimum at a first frequency in a range from about 2500 Hz to about 8000 Hz, and the pair of front side facing windows laminate structure both have a second coincident dip minimum at a second frequency in the range from about 2500 Hz to about 8000 Hz, and wherein the first frequency and the second frequency differ by at least one one-sixth octave interval.

Aspect (16) of this disclosure pertains to the vehicle of Aspect (15), wherein the windshield laminate comprises a first glass sheet and a second glass sheet that differ in thickness and strength levels from one another, and the side window laminate comprises a third glass sheet and a fourth glass sheet that differ in thickness and strength levels.

Aspect (17) of this disclosure pertains to the vehicle of Aspect (15), wherein the windshield laminate comprises a first glass sheet and a second glass sheet that differ in thickness and glass composition from one another, and the side window laminate comprises a third glass sheet and a fourth glass sheet that differ in thickness and glass composition from one another.

Aspect (18) of this disclosure pertains to the vehicle of any one of Aspects (15) through (17), wherein the windshield laminate and the side window laminates have a surface density that is substantially equal.

Aspect (19) of this disclosure pertains to the vehicle of any one of Aspects (15) through (18), wherein the windshield laminate comprises a first annealed glass sheet, an interlayer disposed on the first annealed glass sheet, and a second strengthened glass sheet disposed on the interlayer opposite the first annealed glass sheet.

Aspect (20) of this disclosure pertains to the vehicle of Aspect (19), wherein the side window laminate comprises a third annealed glass sheet adjacent the interior, an interlayer disposed on the third annealed glass sheet, and a fourth strengthened glass sheet disposed on the interlayer opposite the third annealed glass sheet.

Aspect (21) of this disclosure pertains to the vehicle of Aspect (19) or Aspect (20), wherein the first annealed glass sheet comprises a thickness in a range from about 1.5 mm to about 2.5 mm and the first strengthened glass sheet comprises a thickness in a range from about 0.7 mm to about 2.5 mm, and wherein third annealed glass sheet comprises a thickness in a range from about 1.5 mm to about 2.5 mm, and the fourth strengthened glass sheet comprises a thickness in a range from about 0.5 mm to about 2.5 mm.

The disclosure has been described with reference to various specific embodiments and techniques. However, it should be understood that many variations and modifications are possible while remaining within the scope of the disclosure.

1. A vehicle comprising:
a vehicle body enclosing an interior;
a forward-facing opening in communication with the interior;
a windshield laminate having a first surface density (kg/m²) disposed in the forward-facing opening;
at least one side facing opening adjacent the forward-facing opening; and
a side window laminate having a surface density substantially equal to the first surface density disposed in the one side facing opening,
wherein, within a frequency range from about 2500 Hz to about 8000 Hz, the windshield laminate comprises a first coincident dip minimum at a first frequency, and the side window laminate comprise a second coincident dip minimum at a second frequency, and
wherein the first frequency and the second frequency differ by at least one one-sixth octave interval.

2. The vehicle of claim 1, wherein the absolute difference between the first frequency and the second frequency differ by one half of one-third octave interval.

3. The vehicle of claim 1, wherein the absolute difference between the first frequency and the second frequency is from one half to five one-third octave intervals.

4. The vehicle of claim 1, wherein the absolute difference between the first frequency and the second frequency is from one to two ⅓ octave intervals.

5. The vehicle of claim 1, wherein absolute difference between the first frequency and the second frequency is at least two ⅓ octave intervals.

6. The vehicle of claim 1, wherein one of or both the first frequency and the second frequency are less than 3000 Hz or greater than 5000 Hz.

7. The vehicle of claim 1, wherein the windshield laminate comprises a first annealed glass sheet, an interlayer disposed on the first annealed glass sheet, and a second strengthened glass sheet disposed on the interlayer opposite the first annealed glass sheet.

8. The vehicle of claim 1, wherein the side window laminate comprises a third annealed glass sheet adjacent the interior, an interlayer disposed on the third annealed glass sheet, and a fourth strengthened glass sheet disposed on the interlayer opposite the third annealed glass sheet.

9. The vehicle of claim 7, wherein the first annealed glass sheet comprises a thickness in a range from about 1.5 mm to about 2.5 mm and the first strengthened glass sheet comprises a thickness in a range from about 0.7 mm to about 2.5 mm, and wherein third annealed glass sheet comprises a thickness in a range from about 1.5 mm to about 2.5 mm, and the fourth strengthened glass sheet comprises a thickness in a range from about 0.5 mm to about 2.5 mm.

10. The vehicle of claim 7, wherein the first annealed glass sheet and the second strengthened glass sheet have a thickness of about 2.1 mm, the third annealed glass sheet has a thickness of about 1.8 mm and the fourth strengthened glass sheet has a thickness of about 0.7 mm, wherein the vehicle, and wherein the difference between the first frequency and the second frequency is two ⅓ octave intervals or greater.

11. The vehicle of claim 7, wherein the interlayer comprises a tri-layer interlayer having a total thickness in a range from about 0.76 mm to 0.84 mm, wherein the tri-layer comprises two outer layers each having of thickness in a range from about 0.30 mm to 0.37 mm, and an acoustic damping core layer having a thickness in a range from about 0.08 mm to 0.15 mm.

12. The vehicle of claim 1, wherein the windshield laminate has a surface density in a range from about 7.3 kg/m² to 13.4 kg/m².

13. The vehicle of claim 1, wherein the vehicle is is a driver or driverless vehicle selected from an automobile, a sport utility vehicle, a truck, a bus, a train, a watercraft, or an aircraft.

14. The vehicle of any claim 1, further comprising a second side window laminate, wherein the windshield laminate is disposed between the side window laminates and is separated from each side window laminate by a pillar.

15. A method of reducing vehicle cabin noise comprising:
installing a windshield laminate, and at least a pair of front side window laminates in a vehicle cabin,
wherein the windshield laminate has a first coincident dip minimum at a first frequency in a range from about 2500 Hz to about 8000 Hz, and the pair of front side facing windows laminate structure both have a second coincident dip minimum at a second frequency in the range from about 2500 Hz to about 8000 Hz, and wherein the first frequency and the second frequency differ by at least one one-sixth octave interval.

16. The method of claim 15 wherein the windshield laminate comprises a first glass sheet and a second glass sheet that differ in thickness and strength levels from one another, and the side window laminate comprises a third glass sheet and a fourth glass sheet that differ in thickness and strength levels.

17. The method of claim 15, wherein the windshield laminate comprises a first glass sheet and a second glass sheet that differ in thickness and glass composition from one another, and the side window laminate comprises a third glass sheet and a fourth glass sheet that differ in thickness and glass composition from one another.

18. The method of claim 15, wherein the windshield laminate and the side window laminates have a surface density that is substantially equal.

19. The method of claim 15, wherein the windshield laminate comprises a first annealed glass sheet, an interlayer disposed on the first annealed glass sheet, and a second strengthened glass sheet disposed on the interlayer opposite the first annealed glass sheet.

20. The method of claim 19, wherein the side window laminate comprises a third annealed glass sheet adjacent the interior, an interlayer disposed on the third annealed glass sheet, and a fourth strengthened glass sheet disposed on the interlayer opposite the third annealed glass sheet.

21. The method of claim 19, wherein the first annealed glass sheet comprises a thickness in a range from about 1.5 mm to about 2.5 mm and the first strengthened glass sheet comprises a thickness in a range from about 0.7 mm to about 2.5 mm, and wherein third annealed glass sheet comprises a thickness in a range from about 1.5 mm to about 2.5 mm, and the fourth strengthened glass sheet comprises a thickness in a range from about 0.5 mm to about 2.5 mm.
